(19) United States
(12) Patent Application Publication
(10) Pub. No.: US 2026/0295532 A1
(43) Pub. Date: Oct. 1, 2026

(54) SYSTEMS AND METHODS FOR HIGHLY EFFICIENT ISOTOPE ENRICHMENT BY LIQUID SOLUTION CENTRIFUGATION

(71) Applicant: The Trustees of Columbia University in the City of New York, New York, NY (US)

(72) Inventors: Joseph Francis WILD, New York, NY (US); Yuan YANG, New York, NY (US); Alexander N. HALLIDAY, New York, NY (US); Heng CHEN, New York, NY (US)

(73) Assignee: The Trustees of Columbia University in the City of New York, New York, NY (US)

(21) Appl. No.: 19/206,389

(22) Filed: May 13, 2025

Related U.S. Application Data
(63) Continuation of application No. PCT/US2023/037242, filed on Nov. 14, 2023.
(60) Provisional application No. 63/425,181, filed on Nov. 14, 2022.
(60) Provisional application No. 63/548,245, filed on Nov. 13, 2023.

(51) Int. Cl. B01D 59/20

(52) U.S. Cl. CPC B01D 59/20

(57) ABSTRACT

Methods and systems for enriching for at least one isotope of an element. A sample dissolved in one or more solvents or pure liquid including two or more isotopes of a target element is, the solution/liquid then placed in a vessel having inner and outer portions. Centrifugal force is then applied to the vessel. At least one of the following is then withdrawn from the vessel: a first product from the outer portion of the vessel, the first product enriched for heavier isotopes of the target element, and a second product from the inner portion of the vessel, the second product enriched for lighter isotopes of the target element. The inner portion is closer to the axis of rotation of the vessel than the outer portion. The liquid centrifugation systems and methods are generally applicable to all elements, and capable of enriching isotopes of multiple target elements simultaneously.

### CROSS-REFERENCE TO RELATED APPLICATIONS

This application is a continuation of and claims the benefit of International Application No. PCT/US2023/037242, filed Nov. 14, 2023, that claims the benefit of U.S. Provisional Application Nos. 63/548,245, filed Nov. 13, 2023, and 63/425,181, filed Nov. 14, 2022, which are incorporated by reference as if disclosed herein in their entireties.

### STATEMENT REGARDING FEDERALLY SPONSORED RESEARCH OR DEVELOPMENT

This invention was made with government support under grant no. DE-SC0022256 awarded by the United States Department of Energy. The government has certain rights in the invention.

### BACKGROUND

The discovery of isotopes in the early 20th century led to countless world-changing technologies and applications. Enriched stable isotopes are essential to continued research into the most challenging questions in sustainability and fundamental sciences, such as ⁶Li as the source for generating ³H in nuclear fusion, ⁴⁸Ca as a source for producing superheavy elements and examining the Standard Model, and ¹⁰⁰Mo as a precursor for ^{99m}Tc within the broad field of radiopharmaceuticals.

Various methods have been developed for isotope enrichment, including gas centrifuge, electromagnetism, gas diffusion, chemical exchange, and laser separation. Each method has its own advantages and disadvantages. For example, gas centrifuges are very successful at separating isotopes that can form gaseous molecules at near-ambient temperatures, such as UF₆ for ²³⁵U/²³⁸U, and Ni(PF₃)₄ for ⁶²Ni/⁶⁴Ni, but they are not suitable for isotopes that cannot be gasified at these temperatures, such as Group I and II elements. Moreover, most gaseous precursors are highly toxic. Electromagnetic isotope separation (EMIS) has near-perfect selectivity, but the production rate is extremely low and the cost prohibitively high, making it only suitable for isotopes with a mg-g/year demand. Chemical methods utilize the isotope effects in the Gibbs free energy, e.g., molecular and atomic vibrations, which has been successful for light isotopes particularly with a large (1/M₁-1/M₂) such as H/D and ⁶Li/⁷Li. However, hazardous chemicals are often involved, such as H₂S for H/D and Hg for ⁶Li/⁷Li, and the effect weakens substantially for heavier elements.

Centrifugation is a very energy-intensive process that is difficult to adopt on the industrial scale. Further, isotopes are becoming increasingly scarce and expensive for various reasons, including due environmental regulation, geopolitical conflicts, and market conditions.

What is desired, therefore, are improved systems and methods of isotope enrichment with high selectivity and throughput, but also fewer harmful environmental effects.

### SUMMARY

In some embodiments, this technology includes methods and systems for enriching for chemical isotopes using liquid-phase separation. In some embodiments, this technology includes providing a liquid including two or more isotopes of a target element. In some embodiments, the liquid includes a pure elemental liquid, a pure molecular liquid, a solution of a sample dissolved in one or more solvents, or combinations thereof. In some embodiments, this technology includes dissolving a sample containing a target element comprising two or more isotopes of the target element into one or more solvents. In some embodiments, the method includes applying a centrifugal force to the vessel containing the liquid. After centrifugation for the desired time, heavier isotopes of the target element are obtained from the liquid in the outer portion of the vessel located farther from the axis of rotation of the vessel. Lighter isotopes are obtained from the liquid in the inner portion of the vessel that is closer to the axis of rotation. Some embodiments of this technology are applied in continuous centrifugation, including utilizing counterflow centrifugation techniques. Some embodiments of this technology enrich for isotopes of more than one element and including isotopes of one or more solvation elements.

In one embodiment, a method of enriching for at least one isotope of an element is provided. The method in this embodiment comprises dissolving a sample including two or more isotopes of a target element in one or more solvents to form a solution; placing the solution in a vessel having an inner portion and an outer portion; applying a centrifugal force to the vessel; and withdrawing from the vessel at least one of: a first product from the outer portion of the vessel, the first product enriched for heavier isotopes of the target element; and a second product from the inner portion of the vessel, the second product enriched for lighter isotopes of the target element. In this embodiment, the inner portion is closer to the axis of rotation of the vessel than the outer portion.

In some embodiments, the sample is a liquid at working temperature and pressure. In some embodiments, the sample comprises at least one compound including the target element and at least one additional element, and the target element is present in at least two or more isotopes. In some embodiments, the at least one compound comprises one or more salts including CaCl₂, Ca(NO₃)₂, CaS₂O₃, Li₂MoO₄, Li₂SO₄, Na₂MoO₄, or combinations thereof. In some embodiments, the at least one additional element is present in at least two or more isotopes, the method further comprising withdrawing from the vessel at least one of: a third product from the outer portion of the vessel, the third product enriched for heavier isotopes of the at least one additional element; and a fourth product from the inner portion of the vessel, the fourth product enriched for lighter isotopes of the at least one additional element.

In some embodiments, a first solvent includes two or more isotopes of a solvation element, and the method further comprising withdrawing from the vessel at least one of: a fifth product from the outer portion of the vessel, the fifth product enriched for heavier isotopes of the solvation element; and a sixth product from the inner portion of the vessel, the sixth product enriched for lighter isotopes of the solvation element. In some embodiments, the solvent includes water, an organic solvent, liquid nitrogen (N₂), liquified gases, or combinations thereof.

In some embodiments, the method further comprises the step of heating the vessel so that the temperature of the liquid is in the range of about 60° C. to about 100° C. prior to applying a centrifugal force to the vessel.

In some embodiments, the step of withdrawing a first product further comprises withdrawing the about 10% of the liquid volume that is located at the outermost portion of the vessel; and the step of withdrawing a second product further comprises withdrawing the about 10% of the liquid volume that is located at the innermost portion of the vessel.

In some embodiments, the step of applying a centrifugal force to the vessel further comprises applying a centrifugal force for between about 6 hours to about 300 hours. In some embodiments, the step of applying a centrifugal force to the vessel includes centrifuging at between about 30 kRPM and about 200 kRPM.

According to another embodiment, a method of enriching for isotopes of two or more elements is provided, the method comprising: dissolving a sample in one or more solvents to form a solution, the sample comprising at least one compound comprising a first target element and a second target element, and where the first target element and the second target element are present in at least two or more isotopes; placing the solution in a vessel; applying a centrifugal force to the vessel; withdrawing heavier isotopes of the first and second target elements enriched in an outer portion of the vessel from the outer portion; and withdrawing lighter isotopes of the first and second target elements enriched in an inner portion of the vessel from the inner portion, wherein the inner portion is closer to the axis of rotation of the vessel than the outer portion.

In some embodiments, the at least one compound comprises one or more salts including Ca, Mo, Li, K, or combinations thereof. In some embodiments, a first solvent includes two or more isotopes of a solvation element, the method further comprising withdrawing heavier isotopes of the solvation element, and withdrawing lighter isotopes of the solvation element. In some embodiments, the solvent is water and the heavier isotopes of the at least one component element of the solvent comprise ²H and ¹⁸O.

According to another embodiment, a method of enriching for at least one isotope of an element is provided, comprising: dissolving a sample including two or more isotopes of a target element in one or more solvents to form a solution; feeding the solution into a vessel substantially continuously, the vessel having an inner radial portion and an outer radial portion; applying a centrifugal force to the solution up to about 200 kRPM; inducing countercurrent circulation of the solution inside the vessel; withdrawing a first product stream including heavier isotopes of the target element by scooping, via a first scoop mechanism, solution from the outer radial portion of the vessel, the first product stream enriched for heavier isotopes of the target element; and withdrawing a second product stream including lighter isotopes by scooping, via a second scoop mechanism, solution from an inner radial portion of the vessel, the second product stream enriched for lighter isotopes of the target element.

In some embodiments, the step of inducing countercurrent circulation comprises: maintaining a temperature gradient from the outer portion to the inner portion of the vessel such that temperature of outer portion is higher than the temperature of the inner portion; causing the first scoop mechanism to rotate relative to the solution; or combinations thereof.

In some embodiments, the outer portion of the vessel includes a tapered wall such that heavier isotopes flow towards an axial end portion of the vessel.

In some embodiments, continuously administering at least one of the first product and the second product to at least a second countercurrent centrifugation vessel and repeating the steps of applying a centrifugal force, obtaining heavier isotopes, and obtaining lighter isotopes.

In some embodiments, the liquids are in the liquid phase at working temperature and pressure. In some embodiments, liquid-phase processes use ambient temperature and pressure conditions, which promotes safety and greater energy efficiency. In some embodiments, liquid solutions are tuned using salts to customize the separation process and to further increase effectiveness. Some embodiments of this technology will reduce costs to manufacture isotopes at scale, and/or enable the production of isotopes that cannot be manufactured using other separation techniques efficiently.

Embodiments of the present technology can be applied generally to all elements, and can be operated at ambient conditions. In some embodiments, the isotopic systems include Ca, Mo, O, and Li with single-stage selectivities of about 1.046-1.067 per unit mass difference, e.g., 1.434 in ⁴⁰Ca/⁴⁸Ca, 1.134 in ¹⁶O/¹⁸O. In some embodiments, the systems and methods of the present disclosure include performing a three-stage enrichment of ⁴⁸Ca. Additional details and features of the present technology will now be described in reference to the attached drawings.

### BRIEF DESCRIPTION OF DRAWINGS

The drawings show embodiments of the disclosed subject matter for the purpose of illustrating the technology. However, it should be understood that the present application is not limited to the precise arrangements and instrumentalities shown in the drawings, wherein:

FIG. 1 is a chart of a method for enriching for at least one isotope of an element according to embodiments of the present disclosure;

FIG. 2 is a schematic representation of a system for enriching for at least one isotope of an element in a liquid according to some embodiments of the present disclosure;

FIG. 3A is a graph showing equilibrium separation factors versus vessel revolutions per minute for simulated systems and methods of isotope separation in liquid solutions according to embodiments of the present disclosure;

FIG. 3B is a graph showing time-dependent isotope ratio versus location for simulated systems and methods of isotope separation in liquid solutions according to embodiments of the present disclosure;

FIG. 4A is a graph showing simulated and experimental separation factors versus time for isotope separate of three calcium salts according to embodiments of the present disclosure;

FIG. 4B is a graph showing measured separation factors for various target elements undergoing isotope separation according to embodiments of the present disclosure;

FIG. 5 is a chart of a method for enriching for isotopes of two or more elements according to embodiments of the present disclosure;

FIG. 6 is a chart of a method for enriching for at least one isotope of an element according to embodiments of the present disclosure; and

FIG. 7 is a table showing selectivities after each stage for an exemplary 3-stage isotope separation according to embodiments of the present disclosure.

### DETAILED DESCRIPTION

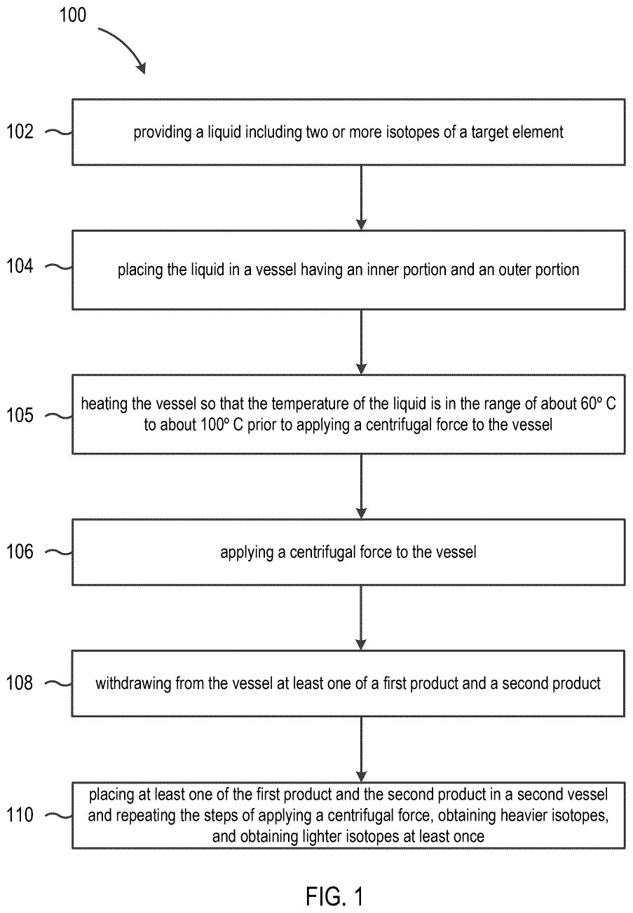

Referring now to FIG. 1, some embodiments of the present disclosure are directed to a method 100 of enriching for at least one isotope of an element in a liquid. In some embodiments, the liquid is a pure elemental liquid including a target element, e.g., liquid phase lithium, potassium, rubidium, etc. In some embodiments, the liquid is a pure molecular liquid composition, e.g., TiCl₄, VCl₄, Fe(CO)₅, etc. In some embodiments, the liquid includes two or more isotopes of the target element, e.g., titanium and/or chlorine inside TiCl₄; vanadium inside VCl₄; iron, carbon, and/or oxygen inside Fe(CO)₅, etc. In some embodiments, the liquid includes a sample dissolved in one or more solvents to form a solution, as will be discussed in greater detail below.

In some embodiments, at 102, a liquid including two or more isotopes of a target element is provided. In some embodiments, the liquid includes one or more pure elemental liquids, a pure molecular liquids, solutions of one or more samples dissolved in one or more solvents, or combinations thereof. In some embodiments of step 102, a sample is dissolved in one or more solvents to form the solution, e.g., the liquid. In some embodiments, the sample includes two or more isotopes of the target element. In some embodiments, the sample is a liquid at standard temperature and pressure. In some embodiments, the sample is a liquid at working temperature and pressure, e.g., methanol sample in H₂O solvent. In some embodiments, the sample is a solid at standard temperature and pressure, and fully dissolvable or substantially fully dissolvable in the one or more solvents. In some embodiments, the sample is a solid at working temperature and pressure, and fully dissolvable or substantially fully dissolvable in the one or more solvents. In some embodiments, the one or more solvents includes any composition suitable for dissolving or fully dissolving the sample, e.g., water, an organic solvent (e.g., C₄H₉Cl, C₂H₂Cl₂, etc.), liquid nitrogen (N₂), liquified gases, or combinations thereof. In some embodiments, the solvent includes two or more isotopes of the target element, e.g., hydrogen and/or oxygen inside water, etc. As will be discussed in greater detail, method 100 is generalizable to liquids and samples including any pair of isotopes, including those that have traditionally been difficult or impossible to separate via gas centrifugation processes.

In some embodiments, the liquid includes at least one compound including the target element and at least one additional element, and wherein the target element is present in at least two or more isotopes. In some embodiments, the sample includes at least one compound including the target element and at least one additional element, and wherein the target element is present in at least two or more isotopes. In some embodiments, the sample includes one or more salts, for example, CaCl₂, Ca(NO₃)₂, CaS₂O₃, Li₂MoO₄, Li₂SO₄, Na₂MoO₄, or combinations thereof.

In some embodiments, at 104 the liquid, e.g., a solution, is placed in a vessel having an inner portion and an outer portion. In some embodiments, the liquid is maintained at a temperature within the vessel between about OK and about 600K. In some embodiments, the liquid is maintained at a temperature within the vessel between about OK and about 500K. In some embodiments, the liquid is maintained at a temperature within the vessel between about 10K and about 600K. In some embodiments, at 105, the vessel is heated so that the temperature of the liquid is in a predetermined range. In some embodiments, the predetermined temperature range is about 60° C. to about 100° C.

At 106, a centrifugal force is applied to the vessel. The vessel is any suitable size and shape to accommodate a desired volume of liquid upon which methods consistent with the embodiments of the present disclosure is to be applied, and further ensure the centrifugal force is applied evenly or substantially evenly to the desired volume of liquid while in the vessel. In some embodiments, the vessel is an elongated container, e.g., a tube, with a closed outer portion to prevent flow of the liquid out of the vessel during application of the centrifugal force. In some embodiments, the vessel includes an inner portion that is closer to an axis of rotation of the vessel than closed outer portion. In some embodiments, the vessel is, or is included in, a concurrent centrifugation apparatus. In some embodiments, the vessel is, or is included in, a countercurrent centrifugation apparatus, as will be discussed in greater detail below.

In some embodiments of step 106, the centrifugal force is applied via rotation of the vessel about an axis of rotation. In some embodiments, the vessel is rotated at between about 30 kilo revolutions per minute (kRPM) and about 200 kRPM. In some embodiments, the vessel is rotated at between about 50 kRPM and about 100 kRPM. In some embodiments, centrifugal force is applied 106 for at least 60 seconds. In some embodiments, centrifugal force is applied 106 for between about 6 hours to about 300 hours. In some embodiments, centrifugal force is applied 106 for between about 24 hours to about 72 hours.

As centrifugal force is applied 106 to the liquid, heavier isotopes in that liquid migrate towards the outermost portions of the vessel, enriching the volumes of liquid at and/or proximate to outer portions of the vessel for heavier isotopes relative to the volumes of liquid at and/or proximate the inner portions. Concurrently, application of centrifugal force 106 results in enrichment of the volumes of liquid at and/or proximate the innermost portions of the vessel for lighter isotopes relative to the volumes of liquid at and/or proximate the outer portions. Thus, during application step 106, heavier isotopes become more concentrated at outer edges of the centrifuge while lighter isotopes become more concentrated at inner edges. The electrostatic force acts to attract the target ions and counter-ions to one another, resulting in charge neutrality. The process minimizes total free energy by forming a density gradient.

Still referring to FIG. 1, in some embodiments, at 108, a product is withdrawn from the vessel. In some embodiments, the product is at least one of a first product and a second product. In some embodiments, these products, e.g., first product and/or second product, are composed of liquid from the vessel. In some embodiments, the first product is withdrawn 108 from an outer portion of the vessel, and thus is enriched for heavier isotopes of the target element. In some embodiments, the second product is withdrawn 108 from an inner portion of the vessel, and thus is enriched for lighter isotopes of the target element. In some embodiments, the inner portion is closer to the axis of rotation of the vessel than the outer portion. In some embodiments, withdrawing 108 includes withdrawing the about 5%, 10%, 15%, 20%, 25%, 30%, 35%, 40%, 45%, 50% or more of the liquid volume that is located at the outermost portion of the vessel. In some embodiments, withdrawing 108 includes withdrawing the about 10% of the liquid volume that is located at the outermost portion of the vessel. In some embodiments, withdrawing 108 includes withdrawing the about 5%, 10%, 15%, 20%, 25%, 30%, 35%, 40%, 45%, 50% or more of the liquid volume that is located at the innermost portion of the vessel. In some embodiments, withdrawing 108 includes withdrawing the about 10% of the liquid volume that is located at the innermost portion of the vessel. Withdrawing 108 of liquid from the vessel can be performed via any suitable process, including gravity or pressure assisted fluid flow, scooping, decanting, syringe extraction, etc., or combinations thereof. In some embodiments, the rotation of the vessel is first reduced to and maintained at a lower RPM, e.g., about 3 kRPM, for a predetermined period of time in an effort to minimize convection-induced remixing the heavier and lighter isotopes, before stopping completely so that product can be withdrawn 108.

As discussed above, in some embodiments, withdrawing 108 includes withdrawing products enriched for heavier/lighter isotopes of the target element, at least one additional element, solvation elements from the one or more solvents that formed the solution, etc., or combinations thereof. In some embodiments, withdrawing 108 includes withdrawing first and/or second products enriched for heavier/lighter isotopes of the target element, e.g., lithium from Li₂MoO₄(aq) in H₂O. In some embodiments, withdrawing 108 also includes withdrawing third and/or fourth products enriched for heavier/lighter isotopes of the at least one additional element, e.g., molybdenum from Li₂MoO₄(aq) in H₂O. In some embodiments, withdrawing 108 also includes fifth and/or sixth products enriched for heavier/lighter isotopes of the solvation element, e.g., hydrogen and/or oxygen from Li₂MoO₄(aq) in H₂O.

In some embodiments, at 110, at least one of the products withdrawn at step 108 are placed in at least a second vessel, and the steps of applying a centrifugal force, e.g., step 106, and withdrawing products enriched for heavier/lighter isotopes, e.g., step 108, are repeated to further enrich those products. In some embodiments, step 110 is repeated one or more times to further enrich the products withdrawn at step 108. Thus, in some embodiments, method 100 includes multiple stage of centrifugation resulting in linear increases in atomic percentage in the product streams, as will be discussed in greater detail below.

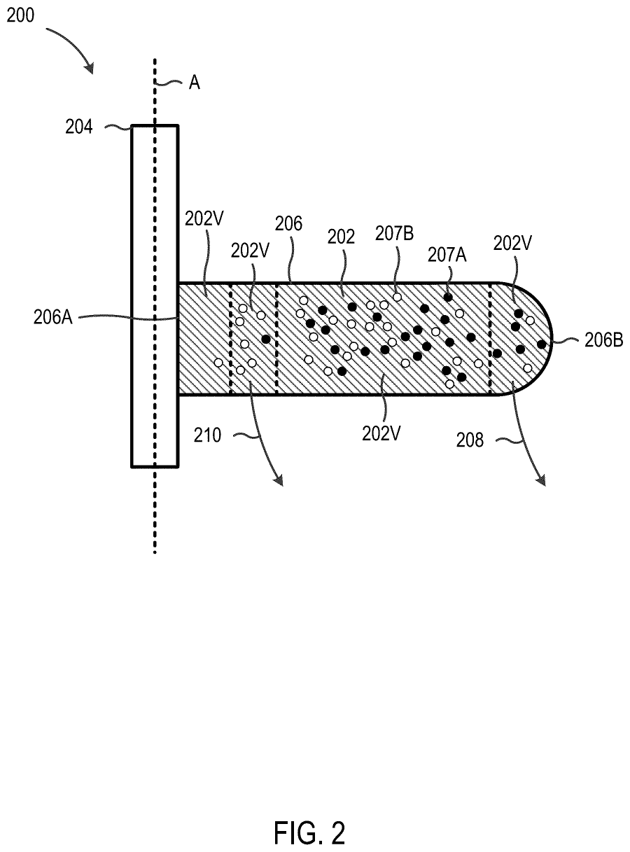

Referring now to FIG. 2, some embodiments of the present disclosure a system 200 for enriching for at least one isotope of an element in a liquid 202. In some embodiment, liquid 202 is provided to a centrifuge 204 and collected in a vessel 206. Vessel 206 includes a first end 206A and a second end 206B, with first end 206A being closer to the vessel's axis of rotation A than second end 206B.

As discussed above, in some embodiments, liquid 202 includes one or more target elements present as a substantially uniform distribution of two or more isotopes. In some embodiments, liquid 202 is a pure elemental liquid. In some embodiments, liquid 202 is a pure molecular liquid composition. In some embodiments, the liquid includes two or more isotopes of the target element. In some embodiments, liquid 202 is a solution formed by dissolving a sample in one or more solvents. In some embodiments, the sample includes two or more isotopes of the target element. In some embodiments, the sample is a liquid at standard temperature and pressure. In some embodiments, the sample is a liquid at working temperature and pressure. In some embodiments, the sample is a solid at standard temperature and pressure, and fully dissolvable or substantially fully dissolvable in the one or more solvents. In some embodiments, the sample is a solid at working temperature and pressure, and fully dissolvable or substantially fully dissolvable in the one or more solvents. In some embodiments, liquid 202 includes one or more pure elemental liquids, pure molecular liquid compositions, solutions, or combinations thereof.

In some embodiments, the one or more solvents includes two or more isotopes of the target element. In some embodiments, the one or more solvents includes water, an organic solvent, liquid nitrogen (N₂), liquified gases, or combinations thereof. In some embodiments, the liquid includes at least one compound including the target element and at least one additional element, and wherein the target element is present in at least two or more isotopes. In some embodiments, the sample includes at least one compound including the target element and at least one additional element, and wherein the target element is present in at least two or more isotopes. In some embodiments, the sample includes one or more salts, for example, CaCl₂, Ca(NO₃)₂, CaS₂O₃, Li₂MoO₄, Li₂SO₄, Na₂MoO₄, or combinations thereof.

Centrifuge 204 rotates vessel 206 about axis A, applying centrifugal force to liquid 202 in the vessel. In some embodiments, the centrifugal radius of centrifuge 204 is between about 0.5 cm and about 100 cm. As discussed above, as centrifugal force is applied to the liquid, heavier isotopes 207A migrate towards vessel end 206B, enriching the volumes of liquid 202V at and/or proximate that end for heavier isotopes relative to volumes of liquid 202V closer to vessel end 206A and axis A. Concurrently, volumes 202V of liquid closer to vessel end 206A are enriched for lighter isotopes 207B relative to volumes of liquid 202V at vessel end 206B. After sufficient centrifugation, e.g., at 60 kRPM for 72 hours, a first product 208 enriched for heavier isotopes 207A can be removed from vessel 206 from at or near vessel end 206B, while a second product 210 enriched for lighter isotopes 207B can be removed from the vessel from at or near vessel end 206A. In some embodiments, products 208 and/or 210 are further processed to isolate a concentration of desired isotopes from those products. In some embodiments, products 208 and/or 210 are provided to additional centrifuges 204 and/or vessels 206 to further enrich them for the desired isotope. In some embodiments, system 200 includes a vessel cascade including greater than 100 centrifuges 204 and/or vessels 206. In some embodiments, system 100 includes a vessel cascade including greater than 1000 centrifuges 204 and/or vessels 206. In some embodiments, centrifuges 204 and/or vessels 206 are operated continuously or substantially continuously to provide continuous or substantially continuous streams of products 208 and/or 210, with each product stream becoming increasingly enriched for the desired isotope as those streams proceed down the vessel cascade.

The centrifuge process described in FIG. 1, step 106, and shown in FIG. 2 is described by Equation 1:

$${J}_{i} = - {D}_{i} ϑ \frac{\partial {c}_{i}}{\partial r} + {D}_{i} \frac{{ω}^{2} r}{RT} {c}_{i} {M}_{i} ( 1 - {\overline{v}}_{i} {ρ}_{soln} ) + {D}_{i} {c}_{i} \frac{{z}_{i} FE}{R T} \qquad ( 1 )$$

$$with$$

$$ϑ = 1 + c \frac{\partial ln ( γ )}{\partial c}$$

where J is the species flux and ‘i’ indexes an ionic isotope, D is the species diffusivity, ϑ is the thermodynamic factor of the Onsager-Fuoss model (which relates the diffusivity, D_{F}, to the purely kinetic diffusivity Dᵢ through D_{F}=ϑDᵢ), c is the molar concentration, r is the radius, ω is the angular velocity, M is the molar mass, R is the gas constant, T temperature, v̅ is the partial specific volume, ρₛₒₗₙ is the density of the solution, z is the valence of the ionic species, F is the Faraday constant, and E is the electric field, y is the activity coefficient.

At equilibrium, the diffusion flux due to the concentration gradient balances the mass-dependent flux arising from centrifugation as well as the electrostatic flux.

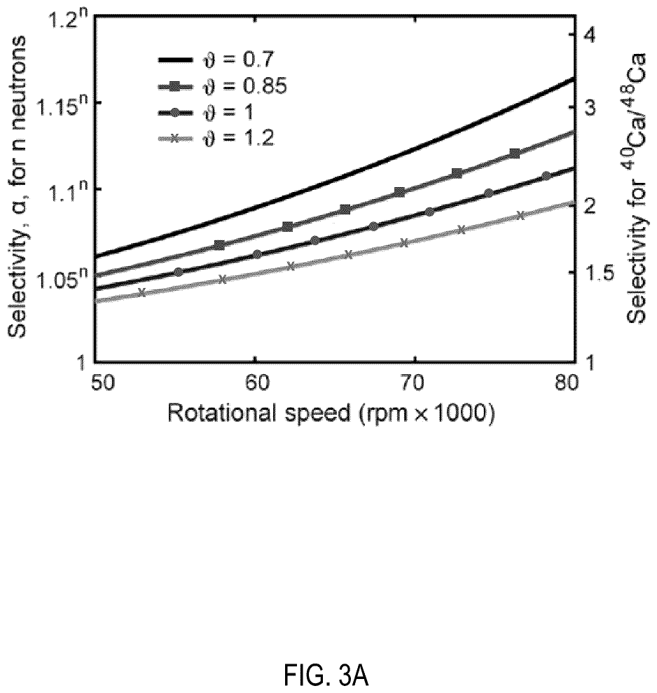

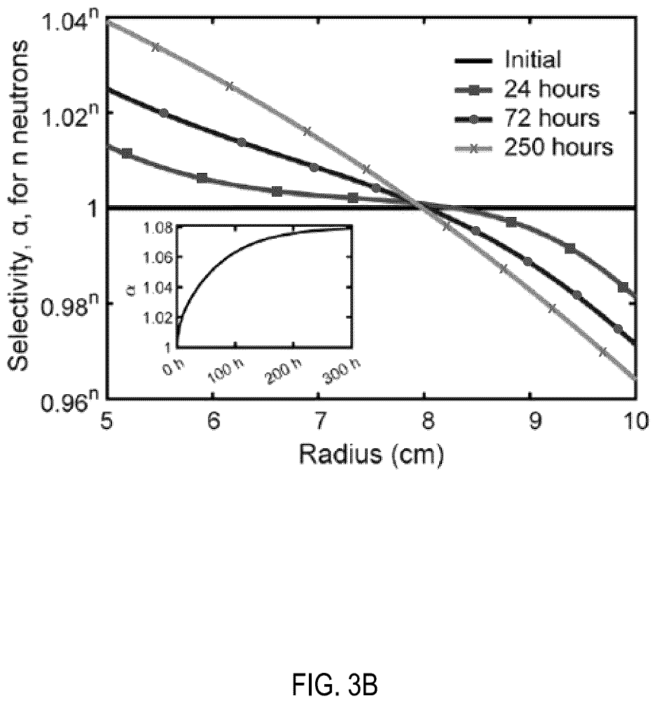

Referring now to FIGS. 3A-3B, the selectivity, a, which is defined as α=([M₁]/[M₂])ᵢₙₙₑᵣ/([M₁]/[M₂])ₒᵤₜₑᵣ with M₁<M₂, can be expressed in equilibrium as

$$α = exp ( \frac{{ω}^{2} ( {M}_{2} - {M}_{1} ) ( {r}_{o}^{2} - {r}_{i}^{2} )}{2 ϑ RT} ) \qquad ( 2 )$$

where rₒ and rᵢ are the outer and inner centrifuge radii, respectively. The selectivity equation is similar to the gas centrifuge case, with the only difference being 9 to account for non-idealities in the liquid solution. This equation has been previously applied to explain isotope fractionations observed in solid and molten metals upon centrifugation at elevated temperatures of >200° C. As shown in FIG. 3A, α can reach 1.05-1.1 per neutron difference at equilibrium at a practical rotation speed, e.g., 50-100,000 revolutions per minute/RPM, which is equivalent to 1.48-2.14 for ⁴⁰Ca/⁴⁸Ca.

Compared to gas centrifuges, liquid centrifuge system such as system 200 have several advantages. System 200 is suitable for most elements while the pool for gas centrifuges is limited. For example, most elements which are difficult to form gaseous species near ambient conditions, such as all Group I and II elements and the lanthanides, are incompatible with the gas centrifuge. In contrast, every element can be made to have good water-solubility, except for the noble gases. Additionally, the isotope concentration in a liquid solution can be much higher than a gas. For instance, 1 mol L⁻¹ isotope solution is 22.4 times as concentrated as a gas at standard conditions, thus increasing throughput. Many elements can be dissolved with a concentration up to 5-10 mol L⁻¹ via a nitrate, nitrite, or halide. Additionally, ϑ is a factor that tends to be below 1 for most aqueous solutions at low concentrations and can become as low as 0.2-0.3 for certain salt/solvent combinations, particularly multivalent ions and low-dielectric-constant solvents, while ϑ is exactly 1 in an ideal gas. For some embodiments, this could allow for the separation factor to be multiple times greater than a gas centrifuge with the same experimental parameters. Finally, non-reactive solids and liquid solutions are much safer to handle than toxic gases, e.g., UF₆, which have unfortunately led to fatal accidents.

In exemplary embodiments described herein, a sample was enriched for ⁴⁸Ca to demonstrate the capability of liquid centrifugation, and additional samples were enriched for ¹⁰⁰Mo and ⁶Li for further validation to represent broad classes of elements across the periodic table. ⁴⁸Ca has a natural abundance of 0.187%, while ⁴⁰Ca accounts for 96.941% of all Ca isotopes. Calcium has no suitable compound that can be gasified near ambient temperature and is currently produced by EMIS with a low rate of ~10 grams/year and price exceeding $100,000/gram. ¹⁰⁰Mo has a natural abundance of 9.74% and has important radiopharmaceutical applications. The current production method of ¹⁰⁰Mo is either low throughput (EMIS) or involves toxic chemicals such as MoF₆ in gas centrifugation. ⁶Li has a natural abundance of 7.5% and its historical enrichment used over 2 tons of toxic Hg to obtain every 1 kg of enriched ⁶Li via the COLEX process.

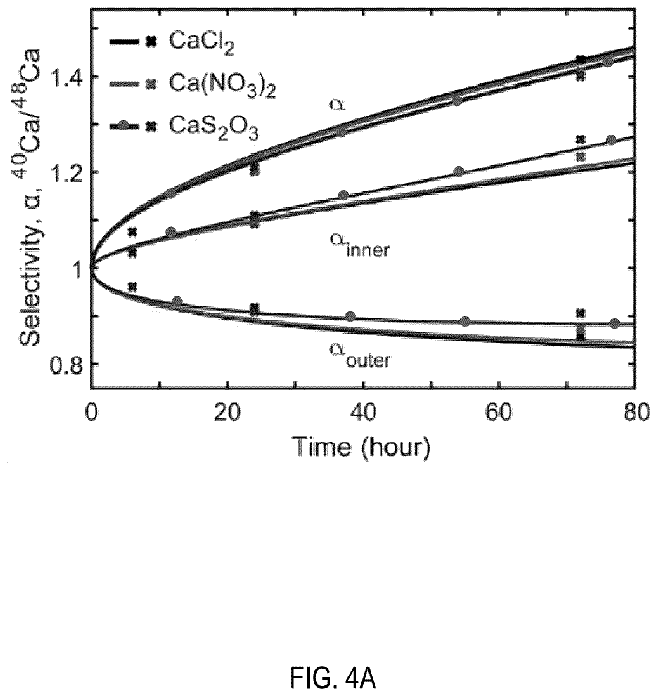

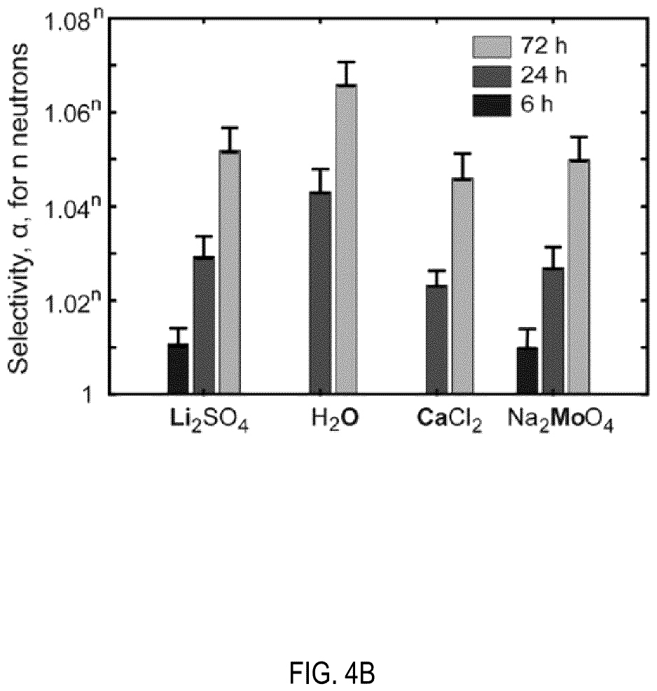

Referring now to FIGS. 4A-4B, high selectivity of 1.434 for ⁴⁰Ca/⁴⁸Ca at 60 kRPM with a commercial biomedical centrifuge after 72 hours, while literature has only reported 1.005-1.012 in chemical separation and 1.26 in 14 day-long thermal diffusion. Similarly, a selectivity of 1.054 was realized in ⁶Li/⁷Li, essentially identical to the COLEX process selectivity, while 1.485 was achieved in ⁹²Mo/¹⁰⁰Mo.

To enrich ⁴⁸Ca by liquid centrifugation, CaCl₂, Ca(NO₃)₂, and CaS₂O₃ were dissolved in water to form 0.1 mol, 1 mol, 2 mol, or 5 mol kg⁻¹ solutions, which were centrifuged in a tube for 24 or 72 hours at 40° C. Samples were then taken from the top and bottom of the tubes and were analyzed with a Nu Instruments Sapphire collision-cell-equipped MC-ICPMS with an ultrahigh accuracy corresponding to <±0.00065 selectivity measurement error. The top and bottom of the tubes correspond to the inner and outer radii, respectively.

First, all salts tended to concentrate at the outer radii since they are denser than water, and the results are consistent with modeling predictions. Heavier ⁴⁸Ca also concentrated at the outer radii compared to ⁴⁰Ca (see FIG. 4B). Upon time, a increases from 1.202/1.201/1.210 at 24 h to 1.434/1.410/1.400 at 72 h for 0.1 M CaCl₂, Ca(NO₃)₂ and CaS₂O₃, respectively, which is consistent with the model prediction that the counterion would not significantly affect α. The uncertainty of α was (+0.028,−0.0003) for 6 h, (+0.035,−0.0003) for 24 hours and (+0.037,−0.0003) for 72 hours. α generally decreased with increasing concentration as the reduced diffusivity slowed down the separation before reaching equilibrium. For example, in CaCl₂, a decreased from 1.202/1.434 at 0.1 M to 1.162/1.352 at 2 M to 1.106/1.194 at 5 M for 24 h/72 h, respectively. However, as the enriched isotope flux is proportional to salt concentration, a higher concentration often favors a larger throughput for practical applications. In some embodiments, the diffusivity can be enhanced by increasing temperature, as it increases by ~2.5%/K in aqueous solution.

It is preferable for a large proportion of the solution to have high isotopic enrichment. To determine the spatial distribution, 10 wt. % gelatin was added in the aqueous solution and the temperature was decreased to 0° C. for the last 3 hours of centrifugation. The solution would mostly gelatinize, and the spatial distribution could be determined without being disturbed by convection. It was found that the heavy isotope is enriched at the bottom ~¼ of the tube, which is consistent with model predictions for the calcium nitrate salt (see FIG. 4B). However, as the salt is more concentrated at the bottom, ~⅓ of the total salt is enriched with ⁴⁸Ca, and ⁴⁰Ca/⁴⁸Ca is roughly linear with atomic percentage in the enriched region.

The exemplary embodiments were applied to ⁶Li/⁷Li, ³⁹K/⁴¹K, and all seven Mo isotopes. In many cases, the same salt was used to separate the isotopes of both the anion and cation, for example Li₂MoO₄. As shown in FIG. 4B, Li₂SO₄ gives a of 1.052 for ⁶Li/⁷Li at 72 hours while Na₂MoO₄ gives an a of 1.485 for ⁹²Mo/¹⁰⁰Mo, which corresponds to 1.0507 per neutron mass difference. Such data confirms that a scales with AM, and demonstrates the universality of the liquid centrifuge method. This is further confirmed by comparing a among different isotope pairs in molybdenum. Moreover, by analyzing ¹H/²H and ¹⁶O/¹⁸O in the solvent, separation factors of 1.067 and 1.134 were found, respectively, thereby indicating that isotopes within the solvent itself were effectively separated. The high self-diffusivity of water and its isotopologues means that 72 hours is sufficient to closely approach equilibrium, thereby explaining the higher value per neutron mass difference of 1.065-1.067 compared to that for dissolved ions.

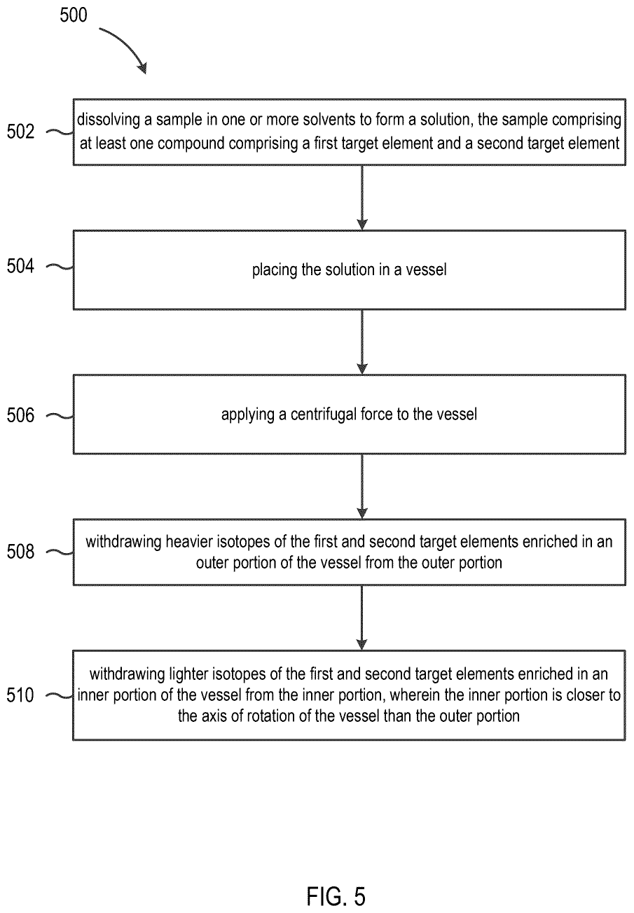

Referring now to FIG. 5, some embodiments of the present disclosure are directed to a method 500 of enriching for isotopes of two or more elements. In some embodiments, at 502, a sample is dissolved in one or more solvents to form a solution. In some exemplary embodiments, the sample includes at least one compound including first and second target elements present in at least two or more isotopes. As a result of dissolution step 502, the isotopes of the first and second target elements substantially evenly distributed in the solution. In some embodiments, the at least one compound comprises one or more salts including Ca, Mo, Li, K, or combinations thereof.

At 504, the solution is placed in a vessel. As discussed above, in some embodiments, the vessel is, or is included in, a concurrent centrifugation apparatus. In some embodiments, the vessel is, or is included in, a countercurrent centrifugation apparatus. At 506, a centrifugal force is applied to the vessel. As discussed above, upon application 506 of the centrifugal force to the vessel, heavier isotopes of the first and second target elements migrate towards the outermost portions of the vessel, enriching the volumes of liquid at and/or proximate to outer portions of the vessel for those heavier isotopes relative to the volumes of liquid at and/or proximate inner portions of the vessel. Concurrently, application 506 induces enrichment of the volumes of liquid at and/or proximate the innermost portions of the vessel for lighter isotopes of the first and second target elements (relative to the volumes of liquid at and/or proximate outer portions of the vessel). Thus, during application step 506, heavier isotopes of first and second target elements become more concentrated at outer edges of the centrifuge while lighter isotopes of the first and second target elements become more concentrated at inner edges.

At 508, heavier isotopes of the first and second target elements enriched in an outer portion of the vessel are withdrawn from the outer portion. At 510, lighter isotopes of the first and second target elements enriched in an inner portion of the vessel are withdrawn from the inner portion. As discussed above, in some embodiments, a first solvent includes two or more isotopes of a solvation element, and heavier isotopes and lighter isotopes of the solvation element are withdrawn. In some embodiments, the solvent is water and the heavier isotopes of the at least one component element of the solvent comprise ²H and ¹⁸O.

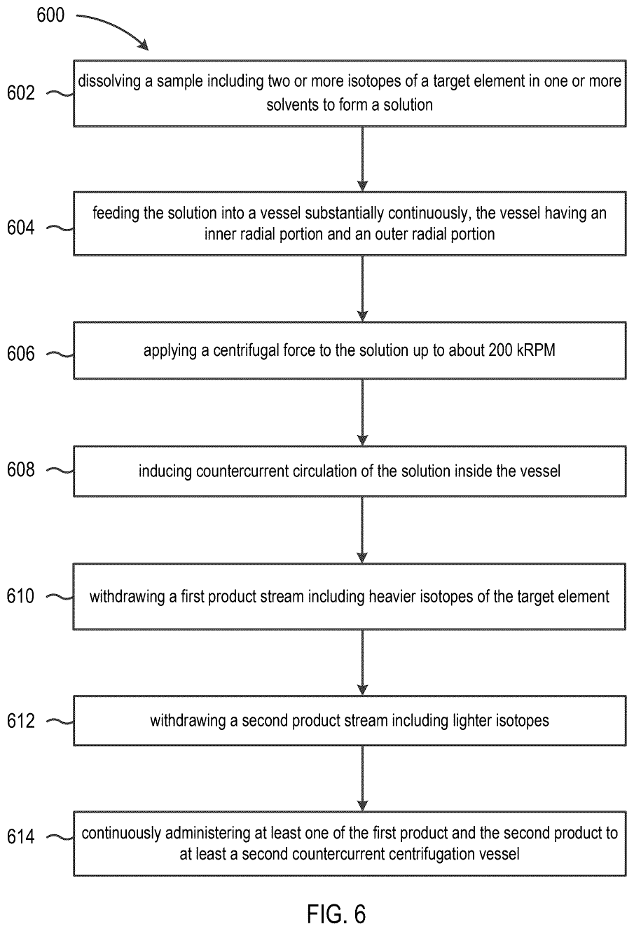

Referring now to FIG. 6, some embodiments of the present disclosure are directed to a method 600 of enriching for at least one isotope of an element. At 602, a sample including two or more isotopes of a target element is dissolved in one or more solvents to form a solution. At 604, the solution is fed into a vessel substantially continuously. In some embodiments, the vessel has an inner radial portion and an outer radial portion. At 606, a centrifugal force is applied to the solution. In some embodiments, the centrifugal force is provided via rotation of the vessel up to 200 kRPM. In some embodiments, the centrifugal force is provided via rotation of the vessel up to 60 kRPM. In some embodiments, the vessel is maintained at about 200 kRPM for about 72 hours. In some embodiments, the vessel is maintained at about 200 kRPM continuously.

In some embodiments, at 608, countercurrent circulation of the solution is induced inside the vessel. In some embodiments, countercurrent circulation is induced 608 by maintaining a temperature gradient from the outer portion to the inner portion of the vessel such that temperature of outer portion is higher than the temperature of the inner portion. In some embodiments, countercurrent circulation is induced 608 by causing the first scoop mechanism to rotate relative to the solution. In some embodiments, countercurrent circulation is induced 608 prior to application of centrifugal force 606. In some embodiments, the outer portion of the vessel includes a tapered wall such that heavier isotopes flow towards an axial end portion of the vessel.

Still referring to FIG. 6, at 610, a first product stream including heavier isotopes of the target element is withdrawn from the outer radial portion of the vessel. In some embodiments, at 612, a second product stream including lighter isotopes of the target element is withdrawn from the inner radial portion of the vessel. In some embodiments, product streams are withdrawn, e.g., at 610 and/or 612, by scooping, via a first scoop mechanism, solution from the relevant radial portions of the vessel. In some embodiments, at 614, at least one of the first product and the second product is continuously administered to at least a second countercurrent centrifugation vessel. In some embodiments, at 614, at least one of the first product and the second product is continuously administered to additional countercurrent centrifugation vessels within a cascade. As discussed above, the steps of applying a centrifugal force 606, obtaining heavier isotopes (step 610), and obtaining lighter isotopes (step 612) can be repeated.

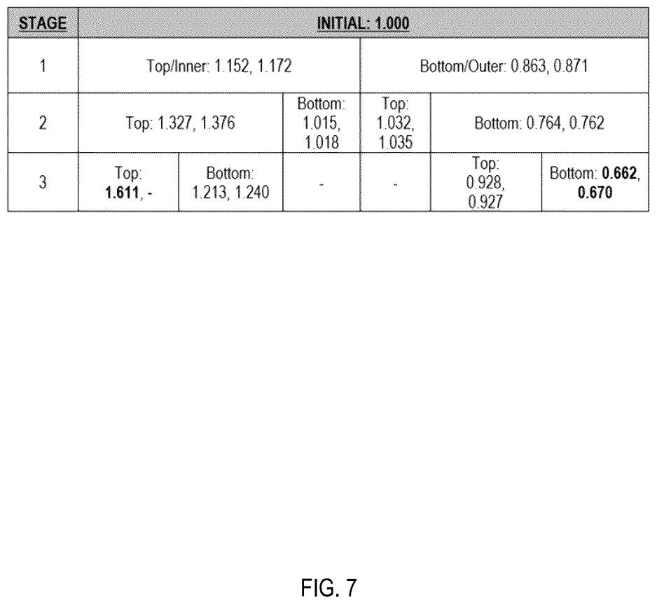

Referring now to FIG. 7, in additional exemplary embodiments of the present disclosure a three-stage enrichment of ⁴⁸Ca was performed. Each solution was centrifuged for 72 hours and then the top and bottom 10% of the solution was collected. These solutions were then diluted and centrifuged for an additional 72 hours, and the process repeated. The ⁴⁸Ca abundance reached 0.282 at % and 0.116 at % after the three-stage enrichment, compared to its natural abundance of 0.187 at %. This corresponds to a separation factor of 2.43 after three stages, or equivalently 2.43^{1/3}=1.34. Given the use of the bottom and top 10% volume in this three-stage embodiment instead of the very bottom and top in a single stage experiment, such results are consistent with a separation factor of ~1.40 in a single stage.

In these exemplary embodiments, the feed and product streams are continuous, while the centrifuge continues to rotate at the target speed. Internal flow profiles are induced which lead to much larger separation factors along the axial direction than can be achieved in the radial direction alone. This has the effect of multiplying the single-stage separation factor by many times depending on the height/diameter ratio, such that even under modest centrifuging conditions selectivities exceeding 1.20 per neutron difference can be achieved, e.g., >4.30 in ⁴⁰Ca/⁴⁸Ca, >1.44 in ¹⁶O/¹⁸O. This countercurrent centrifugation method greatly simplifies the cascading process by reducing the number of stages

### Examples

All solutions to be centrifuged were prepared in 10 g of deionized water (Direct-Q 3 UV water purification system), e.g., 5 mol kg⁻¹ LiCl was prepared by adding 0.05 moles (2.12 g) of anhydrous LiCl to 10 g water. If the salt was initially hydrated, the mass of the water in the hydrated salt was subtracted from the 10 g of water, e.g., 2 mol kg⁻¹ CaCl₂ was prepared by adding 0.02 moles (2.94 g) of CaCl₂·2H₂O to 9.28 g water, since 0.72 g water was already in the hydrated salt. Solutions were prepared in 22 mL polypropylene vials which had been cleaned with deionized water and ethanol to avoid ion contamination from vials. Each centrifuge tube had a volume of around 4.0 mL. Two centrifuge tubes were used for each solution to check repeatability, and these were placed on opposite sides of the rotor after ensuring equal masses for stability.

A SW 60 Ti rotor in the Beckman Optima XPN-100 Ultracentrifuge was used at 60,000 RPM. The inner and outer radii are 63.1 mm and 120.3 mm, respectively. It took 4-5 minutes to reach 60,000 RPM, or 0 RPM at the end of the run. The centrifuge automatically engaged its vacuum system when the rotor reached 3,000 RPM. The rotor was generally initially at 15-20° C. upon starting centrifugation and the heating rate was found to be around 0.4-0.5° C. min⁻¹, so it would take around 1 hour to reach 40° C. At the end of the run, the temperature was set to 25° C. for 1 hour at the same speed to bring the solution closer to ambient conditions and minimize convection-induced remixing upon collection. Open-top thinwall polypropylene tubes were used in all experiments.

For sample collection, 0.5 mm sterile needles were used to collect the samples from the top and bottom of the centrifuge tubes immediately after the end of the run. This process would take around 10 minutes for all six tubes. Generally, 25-75 mg of the sample was collected in each case. The mass of the collected samples was measured by calculating the difference between the mass of the sample container before and after collection to 0.1 mg. This allowed for the concentration to be later determined. The top liquid could be accessed at the top of the centrifuge tube, while the bottom liquid was accessed by carefully removing the thinwall tubes from the bucket and then slowly piercing the bottom of the tube in a twisting motion.

A Nu Sapphire MC-ICPMS (SP004; equipped with collision cell) was used for all K and Ca concentration and isotope measurements under collision cell mode (low-energy mode) to minimize spectral interference from the argon support gas fueling the plasma. A separate Nu Sapphire MC-ICPMS (SP005 without collision cell) was used for all Li and Mo measurements. A Picarro L2130i was used for the water H and O isotope measurements. The collected solutions, as well as the references, were diluted to 50-300 ppb in 2 wt. % nitric acid. Once the concentration measurements had been made by comparing the intensities of the top and bottom solutions to the reference, the concentrations of all samples were brought within 5% of the standard solution concentration. Isotopic measurements were then made three times for each sample, and each analysis included 40 (50 for Li) cycles of 4 s (3 s for Li) integrations. Before isotopic measurements, the calcium samples were first passed through chromatography columns filled with Sr-Spec resin to remove interference element of Sr. The K samples were purified by chromatography columns filled with AG50-X8 cation-exchange resin and measured. Every isotope sample and NIST (National Institute of Standards and Technology) standard solution for that element were measured alternately (sample-standard bracketing) for mass bias and signal drift correction.

Systems and methods of the present disclosure are advantageous in that they utilize elemental liquids, dissolved salts, and other soluble compounds in liquid solutions (aqueous or otherwise) to effectively separate isotopes upon high-speed centrifugation. For example, LiNO₃ or Ca(NO₃)₂ can be dissolved in water to separate lithium or calcium isotopes, respectively. In the exemplary embodiments shown above, the cation-anion pair, solvent, solution concentration and temperature are chosen to define the thermodynamic and kinetic properties of the solution to enhance the magnitude and rate of the separation. These methods can be used in continuous cascade or countercurrent configurations to enrich any element of a certain stable or long-lived isotope (>99% purity), which has far-reaching implications for the large-scale separation of isotopes, e.g., in providing nuclear fuels and other valuable isotopes and materials for the nuclear industry; providing valuable isotopes for space technologies, defense, and other weight-sensitive applications by enriching the lighter isotopes of elements for structures, such as iron and titanium, as a means to reduce the weight of these structures; medical applications, e.g., which rely on tracer-isotopes; scientific research, e.g., which relies on highly enriched special isotopes, for example ⁴⁸Ca in the case of creating superheavy elements and in studying double-beta decay for the standard model, etc. Adjusting the temperature and composition of the liquid phases can further improve the overall throughput of the systems and methods of the present disclosure.

In the exemplary embodiments of the present disclosure, using liquid phases is generally safer than traditional methods including gas centrifugation due to their much easier handling. Moreover, liquid centrifuges can be used at ambient temperatures and pressures in most cases. Salts dissolved in liquids allow for the tuning of the thermodynamic properties of the solution to boost the separation. This is not possible in the gas case. Salts dissolved in liquids can allow for much higher spatial densities of substances/isotopes, allowing for a higher throughput of enriched isotopes.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

We claim:

1. A method of enriching for at least one isotope of an element, comprising:
providing a liquid including two or more isotopes of a target element;
placing the liquid in a vessel having an inner portion and an outer portion;
applying a centrifugal force to the vessel;
withdrawing from the vessel at least one of:
a first product from the outer portion of the vessel, the first product enriched for heavier isotopes of the target element; and
a second product from the inner portion of the vessel, the second product enriched for lighter isotopes of the target element,
wherein the inner portion is closer to the axis of rotation of the vessel than the outer portion
wherein the liquid includes:
a pure elemental liquid, a pure molecular liquid, a solution of a sample dissolved in one or more solvents, or combinations thereof.

2. The method of claim 1, wherein the sample is a liquid at working temperature and pressure.

3. The method of claim 1, wherein the sample comprises at least one compound including the target element and at least one additional element, and wherein the target element is present in at least two or more isotopes.

4. The method of claim 3, wherein the at least one compound comprises one or more salts including CaCl₂, Ca(NO₃)₂, CaS₂O₃, Li₂MoO₄, Li₂SO₄, Na₂MoO₄, or combinations thereof.

5. The method of claim 3, wherein the at least one additional element is present in at least two or more isotopes, the method further comprising withdrawing from the vessel at least one of:
a third product from the outer portion of the vessel, the third product enriched for heavier isotopes of the at least one additional element; and
a fourth product from the inner portion of the vessel, the fourth product enriched for lighter isotopes of the at least one additional element.

6. The method of claim 1, wherein a first solvent includes two or more isotopes of a solvation element, the method further comprising withdrawing from the vessel at least one of:
a fifth product from the outer portion of the vessel, the fifth product enriched for heavier isotopes of the solvation element; and
a sixth product from the inner portion of the vessel, the sixth product enriched for lighter isotopes of the solvation element.

7. The method of claim 1, further comprising the step of heating the vessel so that the temperature of the liquid is in the range of about 60° C. to about 100° C. prior to applying a centrifugal force to the vessel.

8. The method of claim 1, wherein the solvent includes water, an organic solvent, liquid nitrogen (N₂), liquified gases, or combinations thereof.

9. The method of claim 1, wherein the step of withdrawing a first product further comprises withdrawing the about 10% of the liquid volume that is located at the outermost portion of the vessel; and
the step of withdrawing a second product further comprises withdrawing the about 10% of the liquid volume that is located at the innermost portion of the vessel.

10. The method of claim 1, further comprising the steps of placing at least one of the first product and the second product in at least a second vessel and repeating the steps of applying a centrifugal force, obtaining heavier isotopes, and obtaining lighter isotopes at least once to the second vessel.

11. The method of claim 1, wherein the step of applying a centrifugal force to the vessel further comprises applying a centrifugal force for between about 6 hours to about 300 hours.

12. The method of claim 11, wherein the step of applying a centrifugal force to the vessel includes centrifuging at between about 30 kRPM and about 200 kRPM.

13. A method of enriching for isotopes of two or more elements, comprising:
dissolving a sample in one or more solvents to form a solution, the sample comprising at least one compound comprising a first target element and a second target element, wherein the first target element and the second target element are present in at least two or more isotopes;
placing the solution in a vessel;
applying a centrifugal force to the vessel;
withdrawing heavier isotopes of the first and second target elements enriched in an outer portion of the vessel from the outer portion; and
withdrawing lighter isotopes of the first and second target elements enriched in an inner portion of the vessel from the inner portion, wherein the inner portion is closer to the axis of rotation of the vessel than the outer portion.

14. The method of claim 13, wherein the at least one compound comprises one or more salts including Ca, Mo, Li, K, or combinations thereof.

15. The method of claim 13, wherein a first solvent includes two or more isotopes of a solvation element, the method further comprising withdrawing heavier isotopes of the solvation element, and withdrawing lighter isotopes of the solvation element.

16. The method of claim 15, wherein the solvent is water and the heavier isotopes of the at least one component element of the solvent comprise ²H and ¹⁸O.

17. A method of enriching for at least one isotope of an element, comprising:
dissolving a sample including two or more isotopes of a target element in one or more solvents to form a solution;
feeding the solution into a vessel substantially continuously, the vessel having an inner radial portion and an outer radial portion;
applying a centrifugal force to the solution up to about 200 kRPM;
inducing countercurrent circulation of the solution inside the vessel;
withdrawing a first product stream including heavier isotopes of the target element by scooping, via a first scoop mechanism, solution from the outer radial portion of the vessel, the first product stream enriched for heavier isotopes of the target element; and
withdrawing a second product stream including lighter isotopes by scooping, via a second scoop mechanism, solution from an inner radial portion of the vessel, the second product stream enriched for lighter isotopes of the target element.

18. The method of claim 17, wherein the step of inducing countercurrent circulation comprises:
maintaining a temperature gradient from the outer portion to the inner portion of the vessel such that temperature of outer portion is higher than the temperature of the inner portion;
causing the first scoop mechanism to rotate relative to the solution;
or combinations thereof.

19. The method of claim 17, wherein the outer portion of the vessel includes a tapered wall such that heavier isotopes flow towards an axial end portion of the vessel.

20. The method of claim 17, further comprising:
continuously administering at least one of the first product and the second product to at least a second countercurrent centrifugation vessel and repeating the steps of applying a centrifugal force, obtaining heavier isotopes, and obtaining lighter isotopes.
